(19) United States
(12) Patent Application Publication
(10) Pub. No.: US 2025/0138922 A1
(43) Pub. Date: May 1, 2025

(54) RUNTIME RESTRICTION CAPABILITY DISCOVERY AND CACHING

(71) Applicant: T-Mobile USA, Inc., Bellevue, WA (US)

(72) Inventors: Lyle T. Bertz, Lee's Summit, MO (US); Zheng Fang, McLean, VA (US); Galip Murat Karabulut, Vienna, VA (US)

(21) Appl. No.: 18/927,709

(22) Filed: Oct. 25, 2024

Related U.S. Application Data
(60) Provisional application No. 63/593,576, filed on Oct. 27, 2023.

(51) Int. Cl. G06F 9/54

(52) U.S. Cl. CPC G06F 9/547

(57) ABSTRACT

The present disclosure describes approaches for runtime restriction capability discovery and caching. Application programming interfaces (APIs) may expose various functions and accept various inputs. APIs can be implemented by multiple parties. In some cases, not all implementers make all functionality available or accept all inputs. Moreover, the available functionality can vary with time, location, and other factors. Described herein are approaches for information API consumers such as applications of possible restrictions and current restrictions, which can provide improved user experiences and enable graceful failures, among other benefits as described herein. API consumers can access and cache runtime restriction rules, and can subscribe to updates to runtime restriction rules. Current capabilities can be indicated via bit arrays, enabling efficient transmission of current capabilities.

### BACKGROUND

This application claims the benefit of U.S. Patent Application No. 63/593,576, filed on Oct. 27, 2023, entitled RUNTIME RESTRICTION CAPABILITY DISCOVERY AND CACHING, which is hereby incorporated by reference in its entirety.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

As telecommunications technology has advanced and demands by users have increased, there is a need for application developers, service providers, and other users of telecommunication networks to have relatively straightforward ways to determine and use the capabilities of telecommunications networks.

For example, developers may wish to use telecommunications network capabilities for authentication, location determination, network status determination (e.g., whether a smartphone is roaming or not), to request certain network quality (e.g., higher bandwidth, lower latency), to detect SIM swaps, and so forth. For example, a developer of an augmented reality, virtual reality, or extended reality application may want to request a minimum amount of bandwidth, a maximum latency, and so forth to ensure smooth functioning of the application. Latency, bandwidth, or both can be important in many contexts, for example voice over IP calls, video calls, internet gaming, and so forth.

As another example, a developer may wish to determine whether a user is roaming in order to determine if the behavior of an application should change. For example, an application can be configured to delay some or all uploads, downloads, or both when a user is roaming on another network (e.g., a photo syncing application can be configured to pause uploads until the user's smartphone is no longer roaming or is connected to a Wi-Fi network).

Network functionality can also be important for security and privacy. For example, a device's location can be used by a financial institution to determine if a user is located near where a transaction is being attempted. For example, if an individual applies for a loan from a bank, the individual's address can be included as part of the loan application. The bank can query the location of the user's smartphone or other device being used to submit the loan application, which can help to detect potentially fraudulent applications (e.g., if the device is located far from the individual's address). In some cases, a company, for example an e-commerce company or financial institution, can check for recent SIM swaps on a particular line. If a SIM swap recently occurred, the company can take measures to mitigate the risk of fraud. For example, an online peer-to-peer payment platform can detect that a SIM swap has occurred and can disable sending money to or from the corresponding phone number until the number is reverified, or an e-commerce site can require a user to use another form of two factor authentication such as e-mail until a phone number is reverified.

In some cases, network functionality can be used to facilitate transactions. For example, an application or other service can provide functionality that allows users to make purchases and have those purchases billed directly to their mobile service account.

In some cases, edge providers, hyperscalers, and so forth can communicate with a telecommunications network to determine optimal service endpoints, for example to determine which cloud server should be used by an application running a user's device.

While telecommunications networks can offer a great deal of functionality, it can be difficult for application developers to take advantage of such functionality. Networks (e.g., cellular networks) can have different footprints, different capabilities, and so forth. One problem in telecommunications networks can be difficulty determining network capabilities, which can vary over time, in different locations, and so forth. Another can be making use of the capabilities of a network. Network application programming interfaces (APIs) can be used to expose network functionality; however, network APIs can require some telecommunications expertise, which an application developer may be lacking. For example, if an application needs a low latency connection, a developer using network APIs may need to have fairly extensive knowledge of various elements of the network that can be optimized, familiarity with technical terms such as “cell ids” and “slices,” and knowledge of how to use the network APIs to achieve a desired result. Moreover, the terminology used, functionality implemented, and optimizations available can vary from network to network, making implementation that works across networks difficult.

One approach to resolving these difficulties is the use of service APIs that can be that can shield users (e.g., application developers) from the underlying network complexity and difficult-to-use network APIs. Service APIs can be comparatively user-friendly, making it easier for users (e.g., application developers) to take advantage of network functionality. For example, a quality on demand (QoD) API can be provided that enables an application to easily request a low latency connection for a period of time, without the developer needing knowledge of the various network parameters that can be modified to achieve a low latency connection. Thus, the underlying complexity of the network can be abstracted away from the developer.

The use of service APIs can provide various benefits, such as mitigating some privacy issues, making it easier to comply with regulatory requirements (e.g., limiting geolocation accuracy and/or precision), and facilitating the integration of applications with a network. The availability of service APIs across different telecommunications networks, countries, or both, can be important to ensure a seamless customer experience, accelerate technology development and commercialization, accelerate education and promotion, and support application portability.

One project to provide service APIs related to telecommunications is the CAMARA project, an open source effort to define service APIs. These APIs can expose telecommunications network capabilities. The CAMARA APIs can provide a standardized set of APIs that can be used in different countries and across different telecommunications services, enabling users to take advantage of network functionality without needing a deep understanding of telecommunications networks.

However, while the use of service APIs can alleviate many of the problems of network APIs, there are several limitations to current approaches to service APIs. Thus, there is a need for improved service API implementations.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is an illustration of possible and actual network capabilities according to some embodiments.

FIG. 4 is a flowchart that schematically illustrates a process for sharing capabilities and runtime restrictions according to some embodiments.

FIG. 5 is a schematic diagram that illustrates a process for sharing runtime rules according to some embodiments.

FIG. 6 is a diagram that illustrates an example process for providing restriction rules and rule updates to an applications service provider according to some implementations.

FIG. 7 illustrates an example process for sharing runtime restrictions via an intermediary according to some implementations.

FIG. 8 is a flowchart that illustrates an example conflict resolution process according to some embodiments.

FIG. 8 is a block diagram that illustrates components of a computing device.

FIG. 9 is a flowchart that illustrates an example service API process according to some implementations.

FIGS. 10A and 10B schematically illustrate the use of a runtime restriction SDK according to some implementations.

FIG. 11 is a flowchart that illustrates an example process for receiving runtime restriction rules and capabilities according to some implementations.

FIG. 12 is a flowchart that illustrates an example API request validation process according to some implementations.

FIG. 13 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Service APIs can be significant for users such as application developers, cloud service providers, hyperscalers, aggregators, and so forth (generally, API consumers) because they can allow users to take advantage of network functionalities without requiring specialized knowledge. Different telecommunications services can conform to the same set of standardized APIs that can be used across networks. Thus, users can exploit the capabilities of networks without having to tailor code or configurations to specific networks and without having to have a deep understanding of each network.

However, there are significant limitations to current approaches. While there can be a set of standardized APIs, it may not be the case that every telecommunications provider has completely implemented/adopted the APIs. For example, a telecommunications provider may opt not to offer certain features due to regulatory concerns, a lack of sufficient commercial interest, and so forth. Telecommunications operators can impose various restrictions on their services. These restrictions can arise for various reasons. For example, restrictions can exist because of incomplete implementations of certain technology, carrier decisions about which services to offer, laws and regulations, and so forth.

In some cases, even if a telecommunications provider does implement a capability, the telecommunications provider may not make that feature available to every connected device at all points in time. For example, quality on demand services can be disabled during emergencies or other periods of network congestion.

In some cases, a telecommunications provider can deviate from standardized APIs and create their own API versions or forks. A fork can have various differences from the standardized APIs, such as different schema validations (e.g., different allowed values, ranges, formats, etc.). However, if a telecommunications provider were to do this, they would no longer truly be complying with the standardized APIs, and users (e.g., developers) would have to write code to handle provider-specific differences in APIs.

Implementation details for specific telecommunications services are often delivered in a static, out-of-band manner. For example, during development, a developer can implement a provided version of a service API. If updates are made in the future to the service API, the developer may have to recompile and release a new version of an application, and in some cases may have to modify their code. Such an approach can be unsustainable as the number of service APIs increases and the frequency of updates increases. Moreover, developers may have difficulty accessing and understanding the APIs for many different telecommunications services. For example, a developer may not even be aware of the existence of some telecommunications service, may not be able to locate documentation, may not be able to understand documentation (e.g., due to language barriers), and so forth. Additionally, static, out-of-band delivery can mean that an application using service APIs may have information about what features of a network are exposed but may not have information about the current capabilities of the network (e.g., when a capability has been temporarily disabled).

A lack of real-time (or nearly real-time) information about current capabilities and difficulty in ascertaining the exposed capabilities of different networks can mean that developers target only a limited subset of capabilities covered by service APIs, for example only a subset of capabilities that are most commonly implemented. Alternatively, a developer may target a more expanded set of capabilities, but doing so can present an increased risk of failures, which can result in increased development time (e.g., to gracefully handle failures), application instability (which can result if, for example, a developer fails to gracefully handle API call failures), poor user experiences as certain features may fail unexpectedly, and so forth.

Accordingly, there is a need for systems and methods that can provide real-time or nearly real-time information about the exposed capabilities and current capabilities of a telecommunications network. This can be significant because, for example, developers can implement the standardized APIs in the code and, combined with knowledge of exposed and current capabilities, can determine code execution paths (e.g., whether or not to request a low latency connection can be based on whether the network a device is connected to exposes and is currently capable of providing quality on demand services), API call formats, values to pass via API (e.g., passing a value for geolocation accuracy that conforms to both the limitations of the API's schema and to any current limitations (runtime restriction rules that are currently enforced, as described herein)), and so forth. The capabilities exploited by an application can vary over time, by location, and so forth, without the need for a developer to recompile code or to develop highly customized implementations for each telecommunications network. Instead, a developer can take advantage of up-to-date information about the exposed capabilities on a telecommunications network and the currently-offered capabilities of the telecommunication network, and the developer can modify the behavior of their application programmatically based on this information.

There can be a significant number of service APIs, which can offer ways to utilize various functionality that can be provided by a telecommunications network. For example, service APIs offered by the CAMARA project include a blockchain public address API, carrier billing checkout API, device identifier API, device location API, device status API, edge cloud API, home devices quality of delivery (QoD) API, identity and consent management API, number verification API, one-time password (OTP) validation API, quality on demand (QoD) API, Click to Dial API, know your customer (KYC) API, WebRTC API, and SIM swap API.

Representational State Transfer (REST) is a common architectural approach for enabling interaction between computing systems. Internet functionality often utilizes REST, for example in web browsing, which utilizes GET, POST, PUT, DELETE, and other commands and applies those commands to resources according to certain instructions defined on a computing system.

RESTful application programming interfaces (APIs) can enable the exchange of arbitrary information between computing systems, for example between an application running on a user device (e.g., a smartphone) and telecommunications equipment, such as a gateway.

The capabilities of a telecommunications network can be reduced as one moves away from what is theoretically possible to what is currently possible for a given device, at a given location, at a given time, reflecting various decisions by telecommunications companies and the current state of the telecommunications network. In some implementations, network capabilities can be divided into four groupings: what is possible (e.g., what the network could do if configured to do so), what the network will do (e.g., what the network is actually configured to do), what the network will expose (e.g., what capabilities the network exposes, which can vary depending on the source of a request or other factors), and what the network can provide for a particular device at a particular time in a particular location, which can vary based on the device, device location, network state, implementation decisions, or other factors. In some cases, an API can be used to expose what a network can provide to a particular device in a particular location at a particular time but may not expose other information. In some implementations as described herein, information about what capabilities are exposed can be provided. In some implementations, what the network can provide for a particular device in a particular location at a particular time can be shared over the wire per session and in real-time or nearly real-time. In some implementations, information about what capabilities the network exposes can be shared with an application (e.g., an application running on a smartphone) in an out of band manner. While it can be significant to know what the exposed capabilities are, such information can be less time-sensitive than knowing the current capabilities of a telecommunications network.

While it can be important for a client application to be aware of runtime restrictions, it can also be important to limit the amount of network traffic required to share such information. In some implementations, a common API can be used to describe runtime restriction rules for an object published within a service API (e.g., an API defined by the CAMARA project). In some implementations, a system can host a list of runtime restrictions that can be identified by a list of standardized runtime restriction identifiers. In some implementations, each telecommunications operator can define its own runtime restriction identifiers, for example based off real-time or nearly real-time implementation status of supported service APIs on a gateway of a telecommunications network operated by the telecommunications operator. In some implementations, a method can enable a client application to cache runtime restrictions.

In some implementations, a capability discovery and notification API can be configured to allow an operator (e.g., a telecommunications company/service provider) to define and communicate gateway-enforced rules (which can include runtime restriction rules) to subscribed API clients via RESTful in-band bitmap messages. In some implementations, the cost of real-time delivery of runtime restriction rules from gateway to a client application can be minimized or significantly small enough to be viable for use in telecommunications networks. In some embodiments, there can be a mapping between the bits of the bitmap message and corresponding runtime restriction rules, such that active runtime restriction rules (e.g., current capabilities) can be passed in a compact manner.

In some implementations, a runtime restriction API (which can be implemented in a software development kit (SDK)) can provide a programmable interface that developers and other users (e.g., capabilities consumers) (collectively referred to as “users” or “API consumers”) can use to discover API restrictions. The runtime restrictions API can enable users to discover restrictions to services (e.g., operations and values). Runtime restrictions can limit values, limit the use of operations, parameters, schema elements, and so forth. For example, certain functionality can be disabled, certain parameters can be rejected (e.g., a telecommunications service can be configured not to accept an IPV4 address under certain circumstances), geolocation precision can be limited, and so forth. Using runtime restrictions, service API definitions can remain consistent across operators while enabling application service providers to discover restrictions for a specific operator or service.

Runtime restriction rules can be used to advise an application service provider of limitations such as unsupported optional parameters and limitations on device location (e.g., device location may be able to be legally provided with greater or lesser accuracy or precision depending upon where the device is located). Runtime restriction rules can inform an application service provider of different API scopes that require different authorization flows. For example, an operator can use runtime restrictions to define which scopes require which type of authorization flow (e.g., not all APIs or all functionality of an API may be available to all API consumers).

In some implementations, runtime restrictions can be implemented such that runtime restrictions must be configured to result in a valid request for an API and associated API schema. For example, if an API schema restricts the minimum value of a property to 5, but the runtime restriction sets its maximum value to 4, the runtime restriction can be invalid. According to some implementations, invalid runtime restrictions can be ignored by an API consumer (e.g., an application). In some implementations, restrictions can be metadata restrictions (e.g., indicating that a parameter, operation, value, etc., has been deprecated or is read only) or can be general restrictions (e.g., data type, value, enumeration, constant).

In some implementations, runtime restriction rules can apply to primitive types, for example numeric types, string types, array types, and object types. In some implementations, object restrictions can include excluded properties of an object, which can be properties that must not be present in an object. In some implementations, parameters can be restricted. For example, the use of a parameter can be deprecated. In some implementations, parameters can be deprecated if they are not required parameters according to an API schema. In some implementations, the use of an optional parameter can be required. In some implementations, an optional parameter can be required if the API schema to which the restriction rules are applied does not identify the parameter as deprecated. In some implementations, a parameter can be allowed to be empty. Similarly, this can be allowed so long as doing so does not conflict with the API schema.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

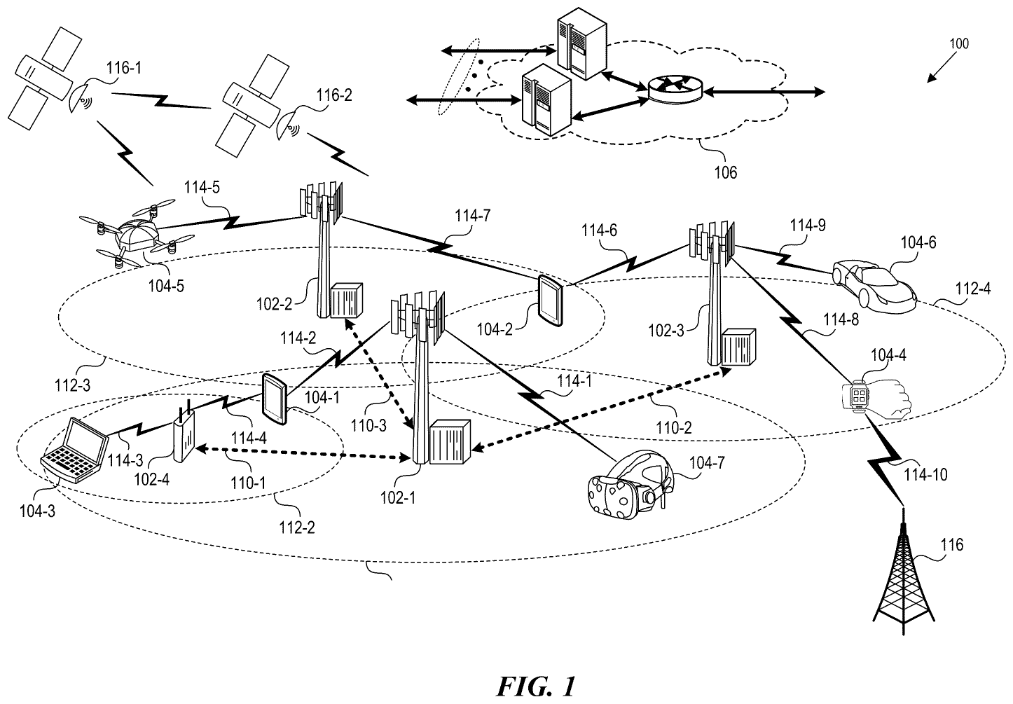

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto cell (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; loT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

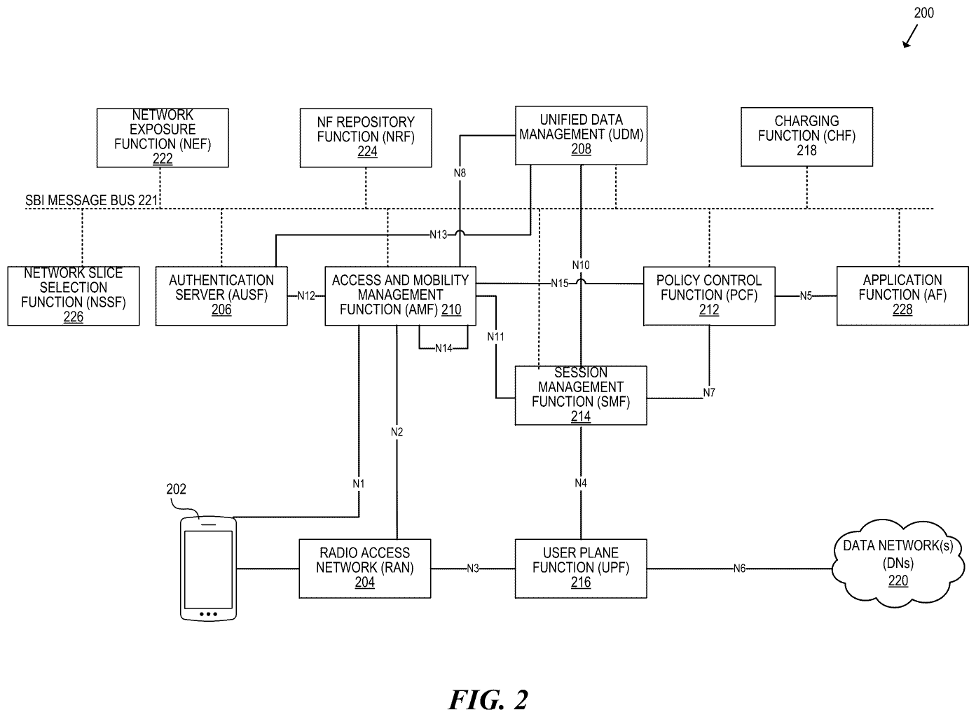

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Runtime Restrictions

As described herein, different telecommunications services can implement different capabilities, availability of certain capabilities may depend on time, location, network status, network load, device type, mobile service plan, whether or not a device is roaming, the particular device connected to the network, and so forth. Capabilities may change based on a change in location of a device. For example, different capabilities can be available during times of relatively low network load, times of high network load, during emergencies, and so forth. Available capabilities can depend on device type, features of a mobile service plan selected by a customer, whether or not a device is roaming, what services a developer pays for, and so forth.

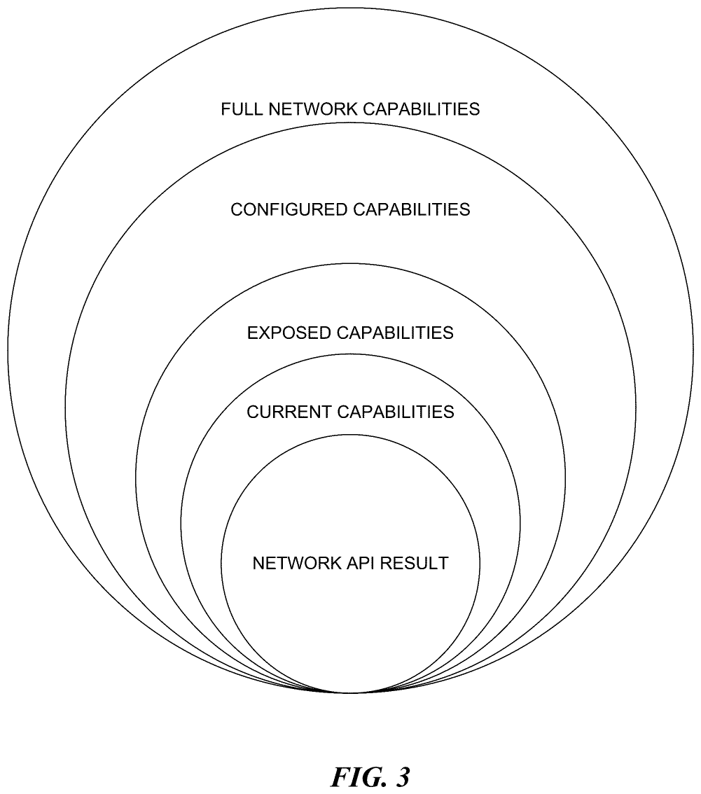

FIG. 3 is an illustration of possible and actual network capabilities according to some implementations. The outer encompassing circle represents the full network capabilities, e.g., what a network is potentially capable of doing, without regard to whether or not any particular capability has actually been implemented or exposed. Within the outer circle are configured capabilities, which can be a subset of the full network capabilities. For example, while a capability may be possible, it may not be configured and thus may be unavailable, a telecommunications provider may have chosen not to pay an equipment vendor to implement a particular capability, and so forth. Within configured capabilities, there can be exposed capabilities. For example, a capability may be configured, but a telecommunications service may choose not to expose the capability so that it can be used. For example, a capability may not be exposed while it is undergoing testing, if problems are observed with a capability, and so forth. Within exposed capabilities there can be current capabilities, which can represent the capabilities that are available for a particular device, at a particular time, in a particular location. Within current capabilities, there can be an actual network API result, which may not include all current capabilities in some circumstances. For example, an API request may nonetheless fail even though the functionality being requested is included in current capabilities. In some implementations, service API calls may take a “best effort” approach, without a guarantee of success.

In some implementations, the number of capabilities can decrease as one goes from what is possible to how a network actually behaves for a particular device at a particular time in a particular location. In some implementations, however, capabilities can be expanded. For example, current capabilities can include one or more capabilities that are not included in exposed capabilities. For example, for a particular device, a telecommunications network may make one or more capabilities available that ordinarily are not exposed. Thus, for example, an API request may succeed even though a capability is not identified as a current capability or an exposed capability. In some implementations, devices connected to a network can be aware of current capabilities, exposed capabilities, or both. In some implementations, other information may not be provided to devices. For example, there may no reason to inform a device of configured capabilities or of full network capabilities, which can include capabilities that are not configured.

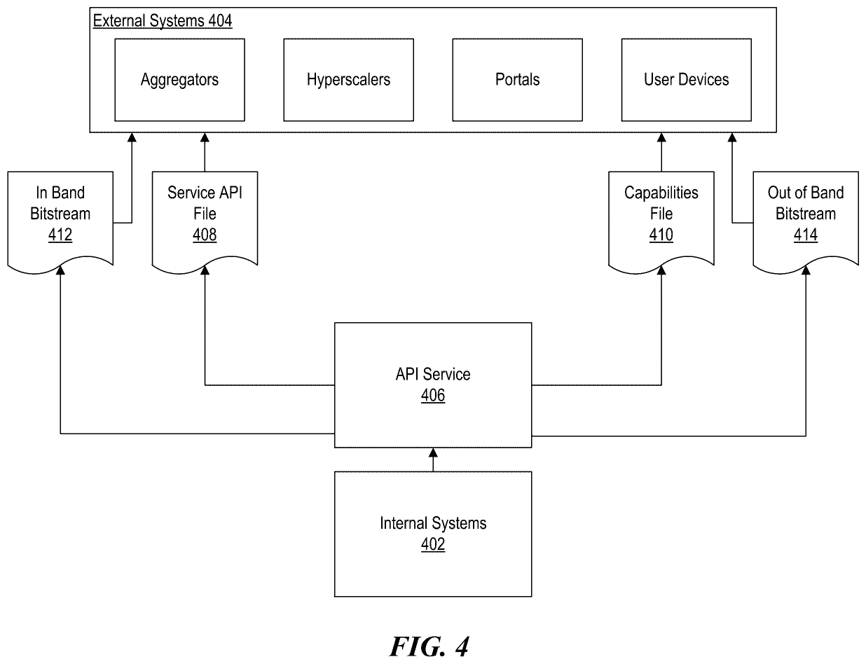

FIG. 4 is a flowchart that schematically illustrates a process for sharing capabilities and runtime restrictions according to some implementations. As shown in FIG. 4, internal systems 402 can communicate with external systems 404 (e.g., hyperscalers, portals, aggregators, end user devices, and so forth) via an API service 406. The API service can provide one or more markup files to the external systems 404. The API service 406 can provide a service API file 408 that indicates the restrictions, e.g., current, real-time (or nearly real-time) restrictions. The API service 406 can provide a capabilities file 410 that indicates network capabilities by topology. The network capabilities by topology can include the capabilities exposed by a network (e.g., the “exposed capabilities” shown in FIG. 3). Thus, for example, the external systems 404 can know both the exposed capabilities of a network and the current restrictions of the network. In some implementations the service API file 408 can be enhanced per session and in real-time or nearly real-time by providing an “over the wire” bitmask stream (also referred to herein as a bit array) that can indicate changes to the current capabilities of a service, for example in-band bitstream 412. In some implementations, the capabilities file 410 can be enhanced by an “out of band” exchange of bits that can indicate changes to the exposed capabilities of a service, for example out-of-band bitstream 414.

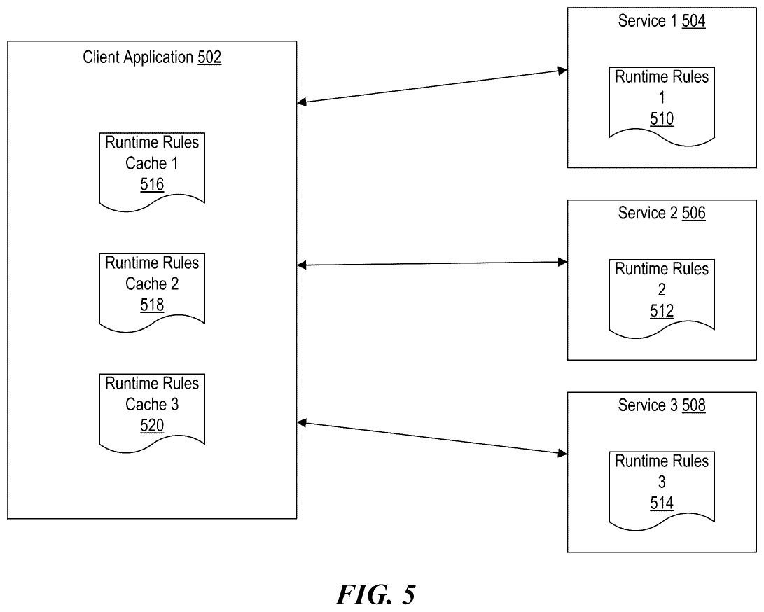

FIG. 5 is a schematic diagram that illustrates a process for sharing runtime restriction rules according to some implementations. As shown in FIG. 5, a client application 502 can communicate with a first service 504, second service 506, and third service 508. In some implementations, each of the services can be operated by a different operator (e.g., by different wireless telecommunication network providers). In some implementations, two or more services can be operated by the same operator. As an example, a network provider may operate in multiple states or multiple countries, and there can be different runtime restrictions within the same network depending upon where a user is located, for example to conform with applicable laws or regulations. The number of services and operators is not necessarily limited. The first service 504 can have first runtime restriction rules 510. The second service 506 can have second runtime restriction rules 512. The third service 508 can have third runtime restriction rules 514. The client application 502 can have a cache of the first runtime rules 516, a cache of the second runtime rules 518, and a cache of the third runtime rules 520. When an operator updates a set of runtime rules associated with a service, the service can send an updated set of runtime restriction rules to the client application 502 if the client application 502 has subscribed to rule updates. Thus, the client application 502 is not necessarily restricted to having a single set of runtime restriction rules, but rather can, in some implementations, cache multiple sets of runtime restriction rules, for example runtime restriction rules associated with different telecommunications services to which a device (e.g., smartphone) on which the client application 502 operates connects. The client application 502 can receive updates to current capabilities via a bit array, which can be associated with a particular cache.

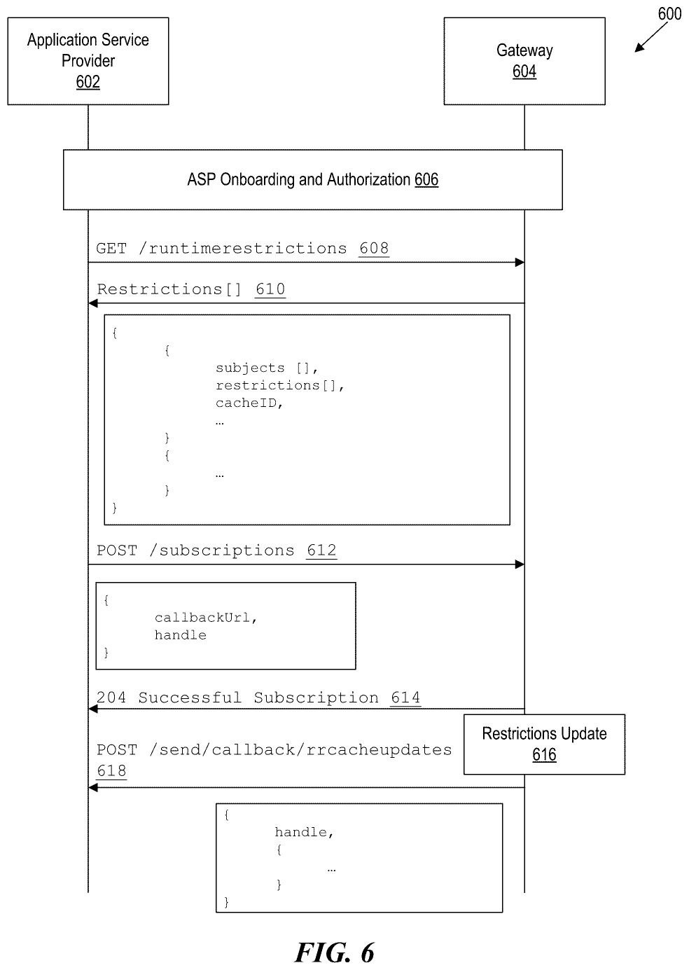

FIG. 6 is a diagram that illustrates an example process 600 for providing runtime restriction rules and runtime restriction rule updates to an application service provider (or API consumer) according to some implementations. An application service provider 602 can be in communication with a gateway 604. The gateway 604 can be a gateway operated by a telecommunications network. At operation 606, the application service provider 602 and gateway 604 can carry out an ASP onboarding and authorization procedure. This procedure can be important as different restrictions may apply to different application service providers, for example based on services the application service provider has subscribed to. After the onboarding and authorization procedure, at operation 608, the application service provider 602 can send a request for runtime restrictions to the gateway 604, for example a GET request. At operation 610, the gateway 604 can send runtime restrictions to the application service provider 602. As shown in FIG. 6, the runtime restrictions can include subjects, restrictions, and a cacheID. The subject can identify a subject of the restrictions. The restrictions can identify particular runtime restriction rules for the subject. As an example, a location verification API can have a device identifier as an input, and “device” can be the subject of the restrictions. The API can be configured to accept multiple identifiers, such as IPv4 address, IPv6 address, phone number, or network access identifiers. A network operator may place restrictions on acceptable identifiers, such as not allowing the use of IPV4 addresses or network access identifiers. The cacheID can be used to identify a particular network or service to which the runtime restriction rules apply. At operation 612, the application service provider 602 can send a subscription request to the gateway 604, for example using a POST command. The subscription request can be a request to receive updates to the runtime restriction rules from the gateway 604. At operation 614, the gateway 604 can send a message to the application service provider 602 indicating that the subscription was successful (or, if the subscription was unsuccessful, can provide an error message, in which case subsequent operations may not be carried out). At operation 616, there can be an update to the restriction rules, which can be triggered automatically, for example in response to changes in the network such as increased network demand or outages, or manually, for example in response to changes to the network such as a new restriction being added manually (e.g., to deprecate part of an API or to enable new capabilities). At operation 618, the gateway 604 can send a cache update to the application service provider 602, for example using a POST command. The cache update can indicate changes in runtime restrictions.

In some implementations, an application can subscribe to restriction rules from a telecommunications service. For example, an application running on a smartphone can be configured to request and/or receive restriction rules directly from a telecommunications service. In some implementations, an application server or other intermediary can be configured to pass restriction rules to a client application running on a different device or the same device as the application server. For example, in a multiplayer online game, the game can be configured to connect to a server operated or controlled by the provider of the game, and the server can communicate with the telecommunications service to determine restriction rules.

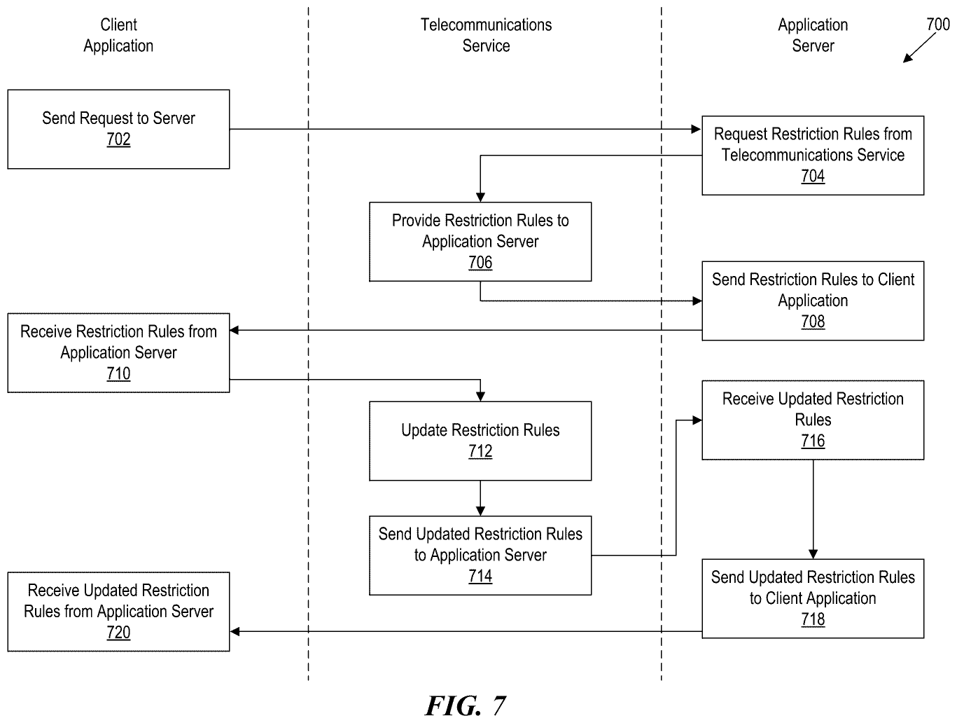

FIG. 7 illustrates an example process 700 for sharing runtime restrictions via an intermediary according to some implementations. At operation 702, a client application can send a request to a server via a telecommunications service. At operation 704, the application server can request restriction rules from the telecommunications service. For example, the application server can request restriction rules from the telecommunications service and can subscribe to updates to the runtime restriction rules. In some implementations, the application server can cache restriction rules, and the application server can provide the cached rules to the client application instead of generating a new request for restriction rules. At operation 706, the telecommunications service can provide restriction rules to the application server. At operation 708, the application server can send the runtime restriction rules to the client application. At operation 710, the client application can receive the runtime restriction rules from the application server. At operation 712, the telecommunications service can update the runtime restriction rules, for example in response to a change in the network status or configuration, and at operation 714, the telecommunications service can send updated restriction rules to the application server. At operation 716, the application server can receive the updated restriction rules and, at operation 718, the application server can send the updated restriction rules to the client application. At operation 720, the client application can receive the updated restriction rules from the application server.

In some implementations, an API can have associated therewith an API schema. The API schema can describe functionality of the API, limitations of the API, and so forth. The API schema can define, for example, which parameters are optional, required, deprecated, and so forth. The API schema can define data types, allowed data values, and so forth. For example, an API schema can be configured to limit the range of a value. As just one illustrative example, an API schema can limit a minimum timeout period to a number between 10 seconds and 60 seconds. In some cases, a telecommunications service provider can configure a runtime restriction rule that is in conflict with the API schema. Continuing with the timeout period example, a runtime restriction rule can limit the minimum timeout period to a number between 2 seconds and 8 seconds. In this example, there is a conflict between the runtime restriction rule and the API schema because the timeout period cannot be both between 2 and 8 seconds and between 10 and 60 seconds. According to some implementations, a runtime restriction can be ignored if it is in conflict with an API schema.

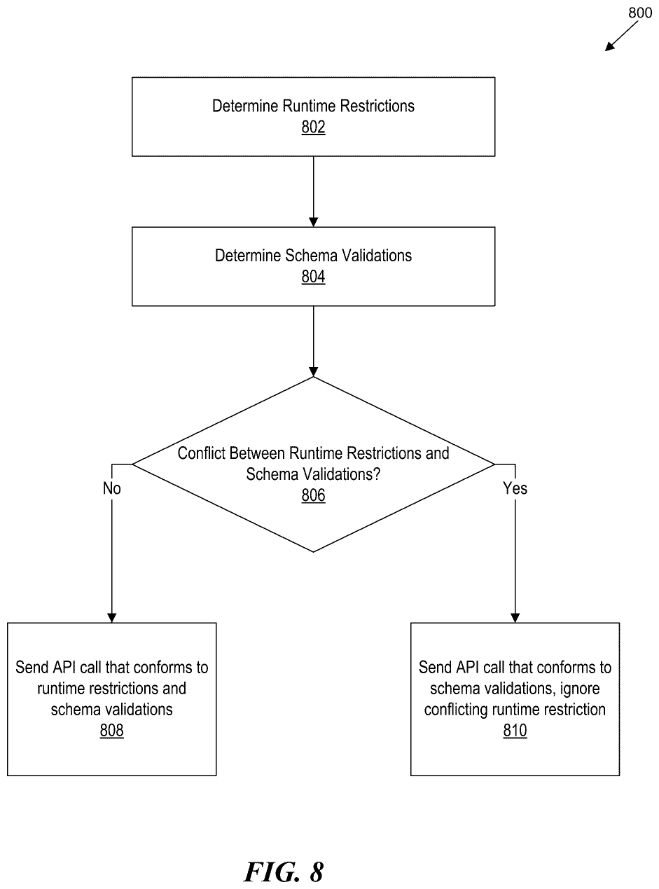

FIG. 8 is a flowchart that illustrates an example conflict resolution process according to some embodiments. At operation 802, a system can determine runtime restrictions for an API call. At operation 804, the system can determine schema validation rules for the API call. In some implementations, the order of application of runtime restriction rules and schema validation rules may not matter. At decision point 806, the system can determine if there is a conflict between the runtime restriction rules and the schema validation rules. If not, the system can send an API call that conforms to both the runtime restriction rules and the schema validation rules at operation 808. When there is a conflict, the system can send an API call that conforms to the schema validation rules and ignores any conflicting runtime restriction rules at operation 810.

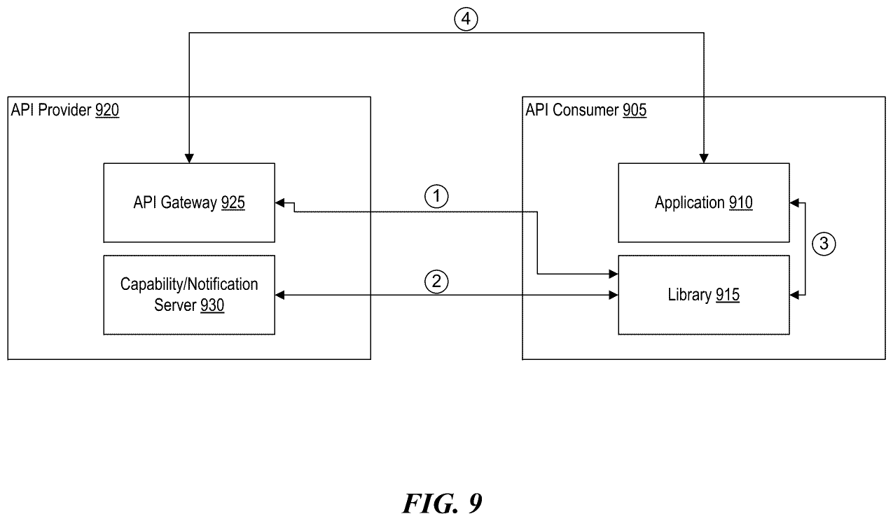

FIG. 9 is a flowchart that illustrates an example service API process according to some implementations. At act 1, an API consumer 905, which can include an application 910 and a library 915, communicates with an API provider 920 (e.g., with an API gateway 925). The library 915 can be a library or SDK that implements runtime restriction capabilities. The application 910 can use the library 915 in forming a valid API request. The API gateway 925 can provide, in response to a request from the API consumer 905, addresses (e.g., URLs) for accessing runtime restrictions and for receiving capabilities and/or capability notifications from a capability/notification server 930. The API gateway 925 and the notification server 930 can be the same system or can be different systems, depending upon the particular implementation. At act 2, the API consumer 905 can access runtime restriction definitions that define one or more runtime restriction rules and/or can access capabilities and/or a bit set definition. As described herein, bit arrays can be used to provide information about current capabilities (e.g., about which runtime restrictions are in effect). The bit set definition can provide a mapping between bits of a bit array and runtime restriction rules. For example, the bit set definition can indicate that the first position in a bit array indicates that a runtime restriction rule related to quality on demand is active if the value is 1 or inactive if the value is 0. That is, the bit set definitions can be used to decode a received bit array to determine which runtime restrictions are active.

In some implementations, at act 2, the API consumer 905 subscribes to runtime restriction updates and or capabilities updates, such that the API consumer 905 receives an update when there is a change to runtime restriction rules and/or to capabilities (e.g., a change in which runtime restriction rules are currently active). In some implementations, getting runtime restriction rule definitions and getting runtime restriction rule updates are carried out as separate actions. In other implementations, subscribing to updates causes runtime restrictions to be downloaded and cached by the API consumer 905 upon initial subscription.

At act 3, the application 910 can utilize the library 915 to determine whether an API request (e.g., a service API request) is valid, for example based on a service API schema and/or currently active runtime restrictions (e.g., based on current capabilities). Thus, the application 910 can check that a request is valid prior to sending the request. At act 4, the API consumer 905 can send an API request (e.g., a service API request such as a quality on demand request) to the API provider 920 (e.g., to the API gateway 925).

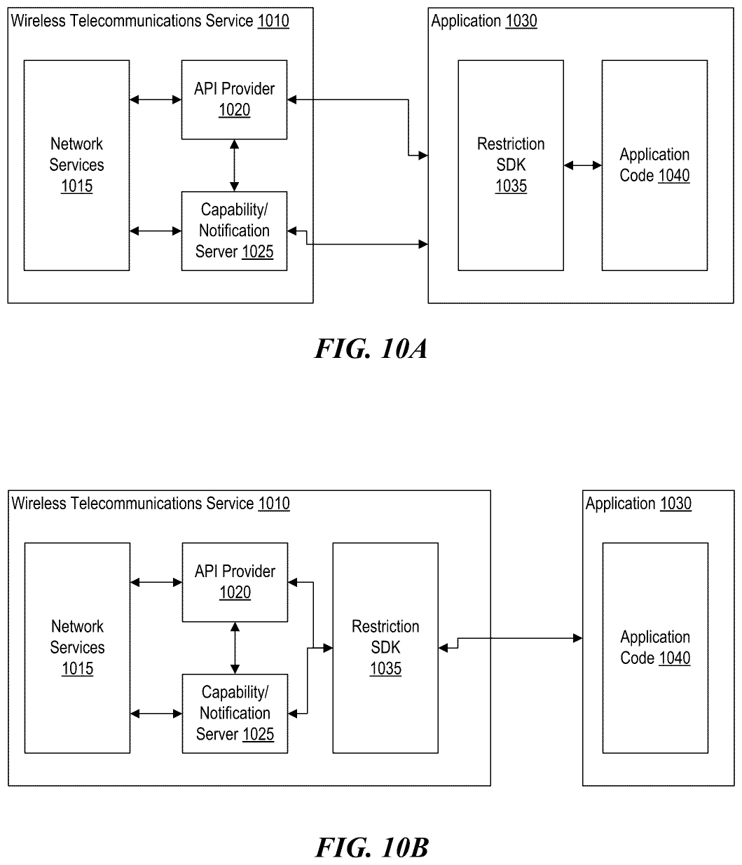

FIGS. 10A and 10B schematically illustrate the use of a runtime restriction SDK according to some implementations. The runtime restriction SDK can enable developers to more easily utilize the approaches described herein. In FIG. 10A, wireless telecommunications service 1010 includes network services 1015, an API provider 1020, and a capability/notification server 1025. The API provider 1020 and notification server 1025 can be the same system or different systems. The API provider 1020 and/or notification server 1025 can be in communication with network services 1015, for example to handle requests to the network services 1015 and/or to obtain information from the network services 1015 about current restrictions. An application 1030 can include a restriction SDK 1035 and application code 1040. The application code 1040 can utilize the SDK 1035 when creating API calls (e.g., service API calls) to be passed to the wireless telecommunications service 1010 (e.g., to the API provider 1020). This can help ensure that the application 1030 complies with applicable restriction rules prior to transmitting an API call to the wireless telecommunications service 1010.

FIG. 10B is broadly similar to FIG. 10A, except that the SDK 1035 is operating on the wireless telecommunications service 1010 rather than the application 1030. Thus, when application 1030 sends an API request (e.g., a service API request) to the wireless telecommunications service 1010, the wireless telecommunications service 1010 can apply the SDK 1035 to determine if the request complies with restriction rules.

In some implementations, FIGS. 10A and 10B are combined, such that the SDK 1035 works both in the application 1030 and the wireless telecommunications service 1010. This can be advantageous because, for example, it enables application 1030 to check that an API request is valid before sending it to API provider 1020. By also utilizing the SDK 1035 within the wireless telecommunications service 1010, compliance with runtime restrictions can be verified by the wireless telecommunications service 1010, rather than assuming that the application 1030 complies with the runtime restrictions.

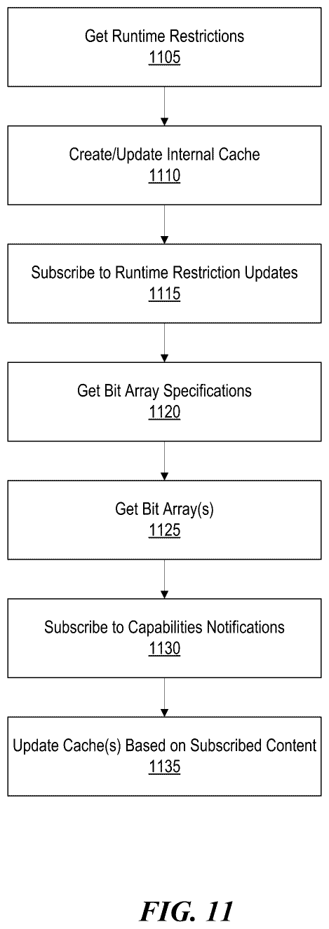

FIG. 11 is a flowchart that illustrates an example process for receiving runtime restriction rules and capabilities according to some implementations. For simplicity, the process is described as being implemented by an application, but it will be appreciated that the process can be implemented at various levels and in various ways, such as at a device or operating system level, and generally by any API consumer. At operation 1105, the application can get runtime restrictions. There can be many different APIs (e.g., service APIs), not all of which are used by the application. Thus, in some cases, rather than requesting all runtime restrictions, the application can request runtime restrictions for particular APIs. As an example, the application can send a request such as ‘GET/runtimerestrictions/{apiname}’ where {apiname} is the name of a particular API utilized by the application. At operation 1110, the application can create or update an internal cache of runtime restrictions. At operation 1115, the application can subscribe to runtime restriction updates.

At operation 1120, the application can get bit array specifications (e.g., bit set definitions). As described herein, the bit array specifications can map restriction rules to bits in a bit array. More generally, the bit array specification can define associations between the bits of a bit array and restriction rules. At operation 1125, the application can get the current bit array(s) (e.g., current capabilities). At operation 1130, the application can subscribe to capabilities notifications, such that the application will receive updates when the capabilities change. At operation 1135, the application can update one or more caches (e.g., cached runtime restrictions, cached bit array specifications, cached bit arrays).

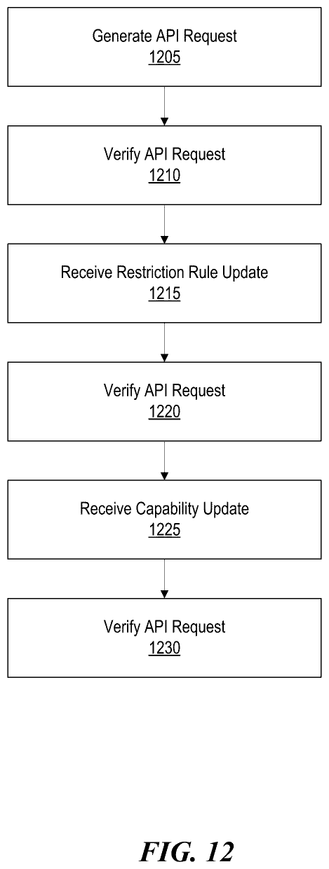

FIG. 12 is a flowchart that illustrates an example API request validation process according to some implementations. At operation 1205, an application can generate an API request. At operation 1210, the application can verify the API request, for example based on cached restriction rules and cached capabilities. At operation 1215, the application can receive or otherwise access a restriction rule update. The restriction rule update can be used to update a local cache of restriction rules. At operation 1220, the application can verify the API request using the updated restriction rules. At operation 1225, the application can receive or otherwise access a capability update, which can indicate that one or more restriction rules have been enabled or disabled. At operation 1230, the application can verify the API request using the restriction rules and the updated capabilities.

In some implementations, an application can utilize runtime restriction rules and/or capabilities information to automatically adjust the appearance and/or behavior of applications. For example, if a runtime restriction is active that limits location to a lower precision, an application may transition away from using precise location and can display “Location” within an application interface instead of “Precise Location.” As another example, if current capabilities don't allow certain features such as quality on demand to be used, applications can adapt their interfaces by, for example, graying out or deactivating certain buttons or other user interface features, or by displaying information in the user interface. As an example, if a video calling application requires a certain quality which is currently unavailable, the video calling application can gray out a video calling option and possibly display a message indicating that video calls are currently unavailable due to network limitations. This can prevent or reduce end user frustration, as users can be prevented from using an application feature at times when that feature will not work and/or can be provided with an explanation for why a certain feature does not work, as opposed to trying to use a feature and having it fail with no explanation or a confusing explanation.

While many implementations herein describe scenarios in which an application or other API consumer subscribes to notifications about runtime restriction rules and/or current capabilities, it will be appreciated that subscriptions are not necessary. For example, in some implementations, an application or other API consumer may perform an initial download of runtime restriction rules and capabilities but may not be subscribed to automatically receive updates. The application may instead, for example, be configured to download runtime restriction rules and/or capabilities on a defined schedule, whenever certain conditions are met (e.g., when a device running the application changes locations), etc.

While described in relation to telecommunications networks, it will be appreciated that the approaches described herein can be applied in a wide variety of circumstances. For example, the approaches described herein can be used in a cloud computing scenario to advise an application of current limitations of a cloud computing service, for example if certain services are temporarily unavailable. As another example, the approaches described herein can be used in address formatting. For example, “runtime restrictions” can describe which address fields are relevant for different locations. For example, address information can include city, state, province, region, trade zone, and so forth. However, not all address information applies depending upon location. Thus, for example, in the United States, a runtime restriction could provide an indication to an application that a service will not accept trade zone or province as part of an address.

### Computer System

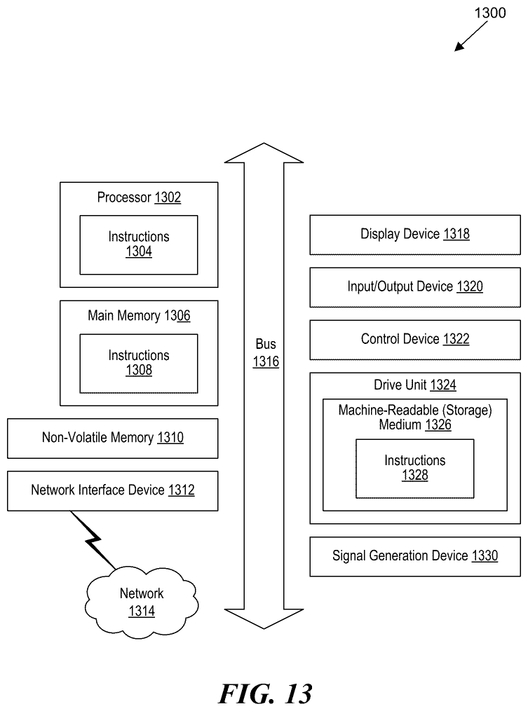

FIG. 13 is a block diagram that illustrates an example of a computer system 1300 in which at least some operations described herein can be implemented. As shown, the computer system 1300 can include: one or more processors 1302, main memory 1306, non-volatile memory 1310, a network interface device 1312, a video display device 1318, an input/output device 1320, a control device 1322 (e.g., keyboard and pointing device), a drive unit 1324 that includes a machine-readable (storage) medium 1326, and a signal generation device 1330 that are communicatively connected to a bus 1316. The bus 1316 represents one or more physical buses and/or point-to-point connections that are connected by appropriate bridges, adapters, or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computing system 1300 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1300. In some implementations, the computer system 1300 can be an embedded computer system, a system-on-chip (SOC), a single-board computer system (SBC), or a distributed system such as a mesh of computer systems, or it can include one or more cloud components in one or more networks. Where appropriate, one or more computer systems 1300 can perform operations in real-time, in near real-time, or in batch mode.

The network interface device 1312 enables the computing system 1300 to mediate data in a network 1314 with an entity that is external to the computing system 1300 through any communication protocol supported by the computing system 1300 and the external entity. Examples of the network interface device 1312 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1306, non-volatile memory 1310, machine-readable medium 1326) can be local, remote, or distributed. Although shown as a single medium, the machine-readable medium 1326 can include multiple media (e.g., a centralized/distributed database and/or associated caches and servers) that store one or more sets of instructions 1328. The machine-readable medium 1326 can include any medium that is capable of storing, encoding, or carrying a set of instructions for execution by the computing system 1300. The machine-readable medium 1326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in computing device(s). When read and executed by the processor 1302, the instruction(s) cause the computing system 1300 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for providing network capabilities information to an application programming interface (API) consumer, the method comprising:
receiving a request for runtime restriction rules from the API consumer;
transmitting, in response to the request for runtime restriction rules, runtime restriction rules to the API consumer,
wherein the runtime restriction rules are transmitted as a structured file,
receiving a request for current capabilities of a wireless telecommunications network;
transmitting, in response to the request for current capabilities, a bit array specification to the API consumer, indicating a mapping of bits of a bit array to restriction rules;
transmitting, in response to the request for current capabilities, the bit array to the API consumer,
wherein the bit array indicates which rules of the runtime restriction rules are currently active;
receiving a request to subscribe to runtime restriction rule updates;
receiving a request to subscribe to current capabilities updates;
determining a change in the runtime restriction rules;
transmitting, to the API consumer, a runtime restriction rule update file indicating the change in the runtime restriction rules;
determining a change in the current capabilities; and
transmitting, to the API consumer, a second bit array indicating updated current capabilities.

2. A method for providing network capabilities information to an application programming interface (API) consumer, the method comprising:
receiving a request for runtime restriction rules from the API consumer;
transmitting, in response to the request for runtime restriction rules, runtime restriction rules to the API consumer,
wherein the runtime restriction rules are transmitted as a structured file;
receiving a request for current capabilities of a wireless telecommunications network;
transmitting, in response to the request for current capabilities, a bit array specification to the API consumer,
wherein the bit array specification indicates an association of bits of a bit array to restriction rules;
transmitting, in response to the request for current capabilities, the bit array to the API consumer,
wherein the bit array indicates which rules of the runtime restriction rules are currently active.

3. The method of claim 2, further comprising:
receiving a request to subscribe to runtime restriction rule updates;
receiving a request to subscribe to current capabilities updates;
determining a change in the runtime restriction rules;
transmitting, to the API consumer, a runtime restriction rule update file indicating the change in the runtime restriction rules;
determining a change in the current capabilities; and
transmitting, to the API consumer, a second bit array indicating updated current capabilities.

4. The method of claim 3, wherein the change in the current capabilities is determined based at least in part on a change in a location of a user equipment upon which the API consumer is operating.

5. The method of claim 2, wherein the current capabilities are based at least in part on one or more of: time, location, network status, network load, device type, mobile service plan, or roaming status.

6. The method of claim 2, wherein current capabilities are transmitted to the API consumer via RESTful in-band bitmap messages.

7. The method of claim 2, wherein the runtime restriction rules include a cache identifier.

8. The method of claim 2, further comprising:
receiving an API request from the API consumer;
validating the API request against the runtime restriction rules and the current capabilities;
when the API request is validated, allowing further processing of the API request; and
when the API request is not validated, not allowing further processing of the API request.

9. The method of claim 8, further comprising, when the API request is not validated:
providing a response to the API consumer indicating that the API request violates at least one runtime restriction rule.

10. The method of claim 2, wherein the structured file is a YAML file.

11. The method of claim 2, wherein each runtime restriction rule of the runtime restriction rules comprises a subject and a restriction.

12. A method for accessing network capability information by an API consumer, the method comprising:
transmitting a request for runtime restriction rules to an application programming interface (API) provider;
receiving, in response to the request for runtime restriction rules, runtime restriction rules from the API provider,
wherein the runtime restriction rules are transmitted as a structured file;
transmitting a request for current capabilities of a wireless telecommunications network;
receiving, in response to the request for current capabilities, a bit array specification from the API provider,
wherein the bit array specification indicates an association of bits of a bit array to restriction rules;
receiving, in response to the request for current capabilities, the bit array from the API provider,
wherein the bit array indicates which rules of the runtime restriction rules are currently active.

13. The method of claim 12, further comprising:
transmitting a request to subscribe to runtime restriction rule updates to the API provider;
transmitting a request to subscribe to current capabilities updates to the API provider;
receiving, from the API provider, a runtime restriction rule update file indicating a change in the runtime restriction rules; and
receiving, from the API provider, a second bit array indicating updated current capabilities reflective of current capabilities of a wireless telecommunications network associated with the API provider.

14. The method of claim 13, wherein the change in the current capabilities is determined based at least in part on a change in a location of a user equipment upon which the API consumer is operating.

15. The method of claim 12, wherein the current capabilities are based at least in part on one or more of: time, location, network status, network load, device type, mobile service plan, or roaming status.

16. The method of claim 12, wherein current capabilities are received via RESTful in-band bitmap messages.

17. The method of claim 12, wherein the runtime restriction rules include a cache identifier, wherein the cache identifier is used to indicate an API provider associated with the runtime restriction rules.

18. The method of claim 12, further comprising:
generating an API request;
validating the API request against the against a cache of runtime restriction rules and a cache of current capabilities;
when the API request is validated, transmitting the API request to the API provider; and
when the API request is not validated, not transmitting the API request to the API provider.

19. The method of claim 18, further comprising, when the API request is not validated:
generating an error an error indicating a runtime restriction rule violated with the API request.

20. The method of claim 12, further comprising:
determining a conflict between a runtime restriction rule and an API schema; and
generating an API request, wherein the API request is compliant with the API schema and is not compliance with the conflicting runtime restriction rule.
